(19) United States
(12) Patent Application Publication
(10) Pub. No.: US 2006/0057247 A1
(43) Pub. Date: Mar. 16, 2006

(54) Low-carbohydrate dairy product

(76) Inventors: Duc Nguyen, Fort Worth, TX (US); Catherine Pinchon-Baratier, Fort Worth, TX (US); Jamie Shepard, Fort Worth, TX (US); Barbara Gutierrez, Fort Worth, TX (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/939,421

(22) Filed: Sep. 14, 2004

(51) Int. Cl. A23C 9/12

(52) U.S. Cl. 426/34

(57) ABSTRACT

A process for producing a low-carbohydrate dairy product comprising producing a low carbohydrate fermented dairy product, especially a fermented dairy product produced using ultrafiltered milk, a low carbohydrate or low glycemic sweetener, and a fruit preparation. This process takes advantage of the naturally acidic nature and enzymatic properties of yogurt-like product and specific mixing steps which produce a product having a suitable viscosity, pH and other organoleptic properties. A low carbohydrate dairy product, such as a fermented dairy product having less than 4.9% carbohydrate.

### BACKGROUND OF THE INVENTION

1. Field of the Invention

The present invention is directed to a process for producing a low carbohydrate dairy product, especially to the formulation of a yogurt-like product and fruit product which is lower in carbohydrates, such as sugars, than conventional yogurt and fruit products.

2. Background Art

Fermented dairy products, such as yogurt, buttermilk and kefir, have been known since ancient times. Today, consumers demand dairy products which not only are more tasty, fun and convenient, but which integrate into a wellness plan, such as a health conscious diet or weight loss regimen. Health conscious diets include diets low in carbohydrates, or relatively low in carbohydrates and relatively high in protein. While fermented dairy products, such as yogurt, contain significant amounts of protein, they are high in milk sugars, such as lactose, and conventional fruit additives and sweeteners usually add even more starches and/or sugars. Therefore, these dairy products are perceived by many consumers as being carbohydrate rich and thus unsuitable for integration into a low carbohydrate diet or regimen.

Many individuals select low-carbohydrate diets to shift their diets away from processed, carbohydrate-rich, but nutrient-poor foods, often for the initial purpose of losing weight or for losing fat and building muscle. Low carbohydrate diets are said to achieve these effects by providing more nutritious proteins and complex carbohydrates which reduce food cravings or subjective feelings of hunger, by lowering the body's carbohydrate stores and inducing ketosis to increase the use of body fat stores for energy, and by reducing the production or release of insulin which converts glucose from carbohydrates in the diet into body fat and prevents the breakdown of stored body fat. Carbohydrates are often seen as inducing quick energy, the so-called sugar-rush, or carbohydrate cravings, and when consumed in excess as being quickly converted into and stored as fat. On the other hand, it is believed that proteins and fats are metabolized in a manner than provides a more steady or uniform energy supply and reduces fat storage. Many low carbohydrate diets are also popular because they do not stress calorie reduction. It is believed that a conventional diet that restricts calories can result in the loss of both fat and muscle mass, but that a diet that only restricts carbohydrate preserves muscle mass while inducing the metabolization of stored body fat.

Other individuals, such as those with diabetes or those who wish to control their blood sugar levels, require or prefer a diet having a low glycemic load. The glycemic load is defined as the amount of carbohydrate in a food multiplied by the glycemic index of that food. Not all carbohydrates are equal in producing rises in blood sugar. A food with a high glycemic index produces a more rapid rise in blood sugar and/or insulin levels, than a food with a low glycemic index. Thus, those individuals who desire to regulate or control their blood sugar may select a diet low in carbohydrate load. Much of the carbohydrate in milk products is from lactose, a milk sugar composed of a unit of glucose and a unit of galactose. Lactose broken down to these units by the enzyme lactase, and the resulting galactose is converted by the liver into glucose. Thus, the carbohydrate in milk products can contribute to rises in blood sugar levels.

High blood sugar levels are associated with disorders of carbohydrate metabolism, including obesity, hyperglycemia, diabetes, development of Type II diabetes, heart disease, nonenzymatic glycosylation and formation of advanced enzymatic end (AGE) products. Also, such high glycemic index foods may cause an increase in appetite, affect mood, and decrease endurance.

Dietary studies suggest that selecting a diet imposing less glycemic load (the glycemic index of foods eaten times the amount of carbohydrate in the foods) on an individual keeps blood sugar low and thus may prevent problems associated with high blood sugar. Conventional whole, low fat or skim milk has a glycemic index of about 31-32, Jenkins et al., Am. J. Clin. Nutr. 34:362-6 (1981). Thus, conventional milk products impose a glycemic load on individuals based on the amount of milk product consumed and based on the glycemic index of these milk products. Thus, to reduce the glycemic load on an individual and obtain the benefits of such a reduction, there is a need to reduce the carbohydrate content or glycemic index, or both, of milk products.

In addition to the need for milk products with low carbohydrate content, there is also a need for dairy-based products with low lactose content. It is estimated that about 25% of the U.S. population and about 75% of the world population has some degree of lactose intolerance. Lactose intolerance is the inability to digest significant amounts of lactose and the degree of intolerance varies from person-to-person. While lactose intolerance generally requires a lactose-restricted diet, many lactose-intolerant individuals can consume foods with some lactose content and thus reduced lactose foods would desirably expand their dietary choices. To provide more varied diet richer in dairy proteins, vitamins A and D and minerals like calcium, for lactose sensitive individuals with the nutritional benefits of dairy products there is a need for dairy products with reduced lactose content.

Low carbohydrate diets may involve limiting carbohydrate to less than 100 gr per day, however, some low carbohydrate regimens limit a subject to less than 20 grams of carbohydrate per day. Conventional milk products which contain high quantities of carbohydrates often do not easily fit within the parameters of such low carbohydrate diets. According to the USDA National Nutrient Database for Standard Reference, Release 16-1 (January, 2004) (see also the www at the following address: nal.usda.gov/fnic/cgi-bin/nut_search.pl) conventional whole milk contains 5.26% carbohydrate (lactose) or about 12.83 gr per 8 oz serving; non-fat milk contains about 4.85% carbohydrate (lactose) or about 11.88 gr per 8 oz serving; plain non-fat yogurt contains about 7.68% carbohydrate or 18.82 grams of sugars per 8 oz serving; and a conventional low fat yogurt and fruit product contains about 19% carbohydrate, or about 47 gr per 8 oz serving. However, low carbohydrate diets which reduce or eliminate dairy product consumption diminish the intake of valuable milk nutrients such as protein, probiotic bacteria, vitamin D and calcium.

Prior methods for the preparation of fermented dairy products employ carbohydrate- and lactose-rich diary products, such as whole, low fat or skim milk. These conventional methods produce fermented products with significant amounts of carbohydrates, even after the fermentation of some of the lactose. On the other hand, developing a low carbohydrate yogurt-like product with acceptable texture and other organoleptic properties from low carbohydrate milk products imposes new problems. While methods for obtaining suitable appearance, texture and taste for many higher carbohydrate yogurt or yogurt-like products made from conventional milk ingredients have been solved, such problems have not been previously adequately addressed for yogurt or yogurt-like products made from low carbohydrate milk products.

The present inventors have discovered a method for producing low carbohydrate yogurt-like products having a suitable texture and other superior organoleptic properties from low carbohydrate milk products, such as ultrafiltered milk. These products have significantly fewer carbohydrates than yogurt or yogurt-like products produced from conventional milk products, such as whole milk, low-fat milk or skim milk and are easily incorporated into a low carbohydrate diet or regimen.

The appearance of yogurt or yogurt-like products produced using conventional milk products and ultrafiltered milk can vary due to the compositional differences in the starting ingredients. For example, the presence of sugars, such as lactose, can help stabilize the viscosity or texture of a fermented milk product. Problems such as protein agglomeration occur when carbohydrates like lactose are removed from a fermented milk product. Such products tend to have unacceptable texture, viscosity or stability. A yogurt-like product with poor texture or stability can separate into liquid and solid components. Such a solid/liquid separation (syneresis) is undesirable for consumer appeal and may reduce the effective shelf life of a product since consumers view a separated yogurt or yogurt-like product as being old, unappealing or unappetizing.

Similarly, the presence of lactose or byproducts of lactose fermentation in a fermented milk product affects its taste by imparting a certain degree of sweetness or tartness to a yogurt or yogurt-like product. Thus, there is a need to determine the appropriate formulations for a low carbohydrate yogurt-like product with acceptable taste and other organoleptic properties.

Despite the significant compositional differences between conventional milk and ultrafiltered milk ingredients, such as the significantly lower amount of lactose, the present inventors have developed methods for making low carbohydrate yogurt-like products with suitable organoleptic properties, including a superior appearance, texture, mouthfeel and taste.

United States regulatory agencies impose certain standards of identity on dairy products. Therefore, while the low-carbohydrate fermented milk products of the invention might be considered by the consumer to be “low carbohydrate yogurts”, such products will be identified herein as low-carbohydrate yogurt-like products or low-carbohydrate fermented milk products. The terms low-carbohydrate milk, low-lactose milk, or ultrafiltered milk may be used synonymously with low-carbohydrate milk product, low-lactose milk product, or ultrafiltered milk product.

The term “low carbohydrate” refers to products low in digestible saccharides or sugars. The low carbohydrate products of the invention may contain glycerol, alcohol, sugar alcohols, non-digestable fiber, or sweeteners containing modified saccharides or sugars which do not substantially add to their net metabolizable carbohydrate content. Net carbohydrate content may be calculated by subtracting nondigestable carbohydrates, such as fiber or sugar alcohols, from the overall carbohydrate content.

### BRIEF SUMMARY OF THE INVENTION

One aspect of the invention is a reduced carbohydrate dairy product for example, a product having less lactose and other sugars than conventional yogurt or milk products and a process for producing such a product in an organoleptically acceptable form. Such a product may be produced using milk products with significantly reduced or no lactose content, such as ultrafiltered milk which has about 80% less lactose than regular milk. Also, fruit preparations having reduced carbohydrate or sugar content may be incorporated into such a product to keep the overall carbohydrate content low. Such products are suitable for a low carbohydrate diet. Such low carbohydrate products may have less than 4.9% carbohydrate. Other reduced carbohydrate values include less than 4.5, 4.0, 3.5, 3.0, 2.5, 2.0, 1.5, 1.0, 0.5 or less. Lactose content is preferably reduced by about 80%, but benefits for lactose sensitive indivuals may also be obtained by lesser reductions in lactose content, such as reductions of 70%, 60%, 50%, 40%, 30%, 20% or less or intermediate values within this range. Sugar values may be reduced by about 90%, 89%, 85%, 80%, 75%, 70%, 65%, 60%, 50%, 40%, 30%, 25%, 20% or 10% or any intermediate value compared to conventional low fat yogurt or yogurt and fruit products. Preferably the sugar content is reduced by at least 80%.

A second aspect of the invention is a reduced carbohydrate fermented dairy product (yogurt-like product) having a reduced lactose content suitable for incorporation into a lactose-restricted diet and a method for producing such a product in an organoleptically acceptable form. Such a product is reduced in lactose content by at least 10-25%, at least 25-50%, or most preferably at least 50-80%. Preferably, the fermented product has at least 80% less sugar, less than 8 grams of carbohydrate per 8 oz serving, and at least 30%-50% fewer calories than regular low fat yogurt.

A third aspect of the invention is a fermented dairy product (yogurt-like product) that provides a reduced glycemic load when consumed compared to a conventional yogurt product. Such a product would include a yogurt-like product and fruit mixture with less carbohydrate that conventional yogurt and fruit products, or a yogurt-like product and fruit product with a lower glycemic index than conventional yogurt and fruit products. Such a product may reduce carbohydrate load by at least 10-25%, 25%-50%, or 50-75% or more.

A fourth aspect of the invention is a reduced carbohydrate fermented milk product as described by the first-third aspects of the invention that also provides pre- or probiotic benefits. For example, a low-carbohydrate yogurt-like product and fruit product having significant amounts (e.g., ≧10⁶ CFU/gr, >10⁸ CFU/gr or >10¹⁰ CFU/gr) of live and active Lactobacillus bulgaricus and Streptococcus bulgaricus bacteria, or optionally, other live and active probiotic bacteria, such as Lactobacillus acidolphilus or Lactobacillus casei. Such a product can help restore the balance of intestinal flora and enhance specific or nonspecific immunity when consumed.

A fifth aspect of the invention is a reduced carbohydrate, reduced lactose, or reduced carbohydrate load fermented milk product (yogurt-like product) having a superior texture and superior organoleptic properties, for example, a low-sugar, low-carbohydrate yogurt-like product having a viscosity ranging from 900-1,600 mPa·s and a pH ranging from 4.0 to 4.6.

A sixth aspect of the invention is a method for producing a low-carbohydrate, reduced lactose, or lowered carbohydrate load fermented milk (yogurt-like product) and fruit product by mixing (1) a low carbohydrate fermented milk product (yogurt-like product) and (2) a fruit preparation to make a product having a viscosity ranging from 500 to 2,000 mPa·s and a pH ranging from 4.3 to 4.7. This aspect of the invention also encompasses the separate addition of supplementary ingredients or additives either to the primary ingredients of low carbohydrate fermented milk product (yogurt-like product) or fruit, or separately during the mixture of the primary ingredients of the fruit- and dairy based product.

### DETAILED DESCRIPTION OF THE INVENTION

Low carbohydrate or low glycemic index fermented milk product (yogurt-like product) may be produced by the fermentation of a low carbohydrate milk product, such as ultrafiltered milk or a mixture containing milk, low-carbohydrate milk proteins, and water.

Ultrafiltration of milk is used to increase the solids level of a milk product and eliminate low molecular mass milk components, such as lactose. Ultrafiltration membranes restrict the passage of milk proteins and fats, but allow the passage of low molecular mass components such as lactose, some milk minerals and water. This process separates milk into a permeate or ultrafiltrate and a concentrate or retentate. After removal of these low molecular mass components the concentrated milk product may be diluted back to its original volume with water, milk minerals or other liquids free of lactose. This results in an ultrafiltered milk product lower in lactose than the unfiltered milk product. Ultrafiltered milk products may be obtained from whole, reduced fat, skim, condensed, or reconstituted dry milk. Such products include ultrafiltered milk, ultrafiltered milk protein concentrate, ultrafiltered/diafiltered milk protein concentrate, or ultrafiltered milk protein paste. Other solid components may be added to an ultrafiltered milk product, such as milk proteins or other solids low in or free of lactose. Ultrafiltration of milk can reduce the carbohydrate content of milk retentate to about 3 grams per 8 oz serving (about 1.3%), compared to about 13 grams per 8 oz serving (about 5.7%) of conventional milk. That is, ultrafiltration can reduce the carbohydrate content of milk retentate by about 80%.

The fermentation mixture used to make the fermented milk (yogurt-like product) component of the present invention, may also contain milk protein concentrates, milk protein isolates, or low lactose milk ingredients low lactose casein, low lactose MPC, or low lactose whey protein, or gelatin. Alternatively, a blend of skim milk, MPC, gelatin, WPC and water may be used in place of all or a part of the ultrafiltered milk. Blends of ultrafiltered milk and/or conventional milk products or other carbohydrates and sugars, may be used to adjust the carbohydrate content of the final product to a desired level.

Generally bovine milk products are used, though yogurt-like product may also be produced from the milk of other mammals, such as goats or sheep. Substitute milk products, such as soy, coconut, rice, or nut milks (e.g., almond or cashew milks) can also be added to or substituted for animal milk mixtures to produce yogurt-like products. The identity and quantity of such milk products may be selected on the basis of their low carbohydrate content, low glycemic index, or on their overall effect on glycemic load.

One method of low carbohydrate yogurt-like product production proceeds by hydrating an ultrafiltered milk mixture. Such a mixture may contain ultrafiltered milk powder, skim milk powder, cream, gelatin, and whey protein concentrate (WPC). Kosher gelatin may be used. WPC with different protein content, such as WPC with protein contents ranging from 35-80%, may be used. After suitable hydration of the ultrafiltered milk mixture occurs, usually after a period ranging from about 30 minutes to 2 hrs, the milk mixture is preheated and homogenized. The resulting mixture is then pasteurized, for example, at a temperature of about 198° F. for approximately 6 to 7 minutes. Pasteurization may be performed in-line using HTST (high temperature short time) procedures. The pasteurized milk mixture is then cooled to a temperature suitable for fermentation by lactose metabolizing bacteria.

The cooled milk mixture is inoculated with appropriate strains of bacteria, such as Lactobacillus bulgaricus and Streptococcus thermophilus. Other strains of lactose-fermenting bacteria may also be added, such as Lactobacillus acidophilus or Lactobacillus bifidus, to assist in the fermentation or provide probiotic properties to the final product.

To augment the probiotic properties of the low carbohydrate yogurt-like product Lactobacillus casei may be added, for example in an amount of ≧10⁵, 10⁶, 10⁷, 10⁸, 10⁹, or 10¹⁰ CFU/ml. Other probiotic microorganisms which may be added in similar amounts either during or after fermentation include Lactobacillus gasseri, Lactobacillus plantarum, Lactobacillus johnsonii, Lactobacillus reuteri, Lactobacillus rhamnosus, Bifidobacterium bifidum, Bifidobacterium lactis, Bifidobacterium longum, Bifidobacterium breve, Bifidobacterium infantis, Enterococcus faecium, Enterococcus faecalis, and Streptococcus salivarius or the yeast Saccharomyces boulardii.

The inoculated milk culture is maintained under conditions favoring curd formation and thus allowed to ferment without substantial agitation. Generally, the fermentation temperature is kept within the range of 102±2° F. When the mixture reaches a pH ranging from about 4.4 to 4.6, usually, about 4.6, it is agitated and cooled to slow or stop the initial fermentation.

The resulting yogurt-like product base product is then held a temperature of about 68 degrees F., and filtered to remove lumps, for instance, by passage through a ⅛ inch wire mesh filter.

The yogurt-like product base product, or white mass, may then be stored at a reduced temperature for 10-15 hours, e.g., at 68° F., until mixing with the fruit preparation.

The fruit preparations may be conventional fruit purees or sauces, or chopped fruit pieces. For ease of consumption, generally fruit pieces are no larger than 6 mm in diameter in the final product.

The typical fruit base is 30-50% fruit with a maximum piece size of ⅛″ to avoid a choking hazard; 30-50% water, 20-25% sugar, such as fructose or sucrose, 0-10% fruit juice (single strength), and 1-5% of a suitable stabilizer, and color (e.g. vegetable or fruit juice concentrate, such as beet or carrot juice concentrate, annatto extract or carmine, or other natural or artificial color), flavor, acid (e.g., citric or malic acid), buffer (e.g., sodium citrate) and/or preservative (e.g., potassium sorbate). Fruit preparations generally contain natural sugars, so to keep sugar content of the product low no sugar need be added to a fruit preparation. Sugar content in such fruit preparations may range from 0% to about 2% and the corresponding carbohydrate content of such fruit preparations may range from 2-10%, for example, from 5-8%. These sugar and carbohydrate content values include all intermediate values and subranges. Fruit juice may be added as a concentrate or at single strength and from a single type of fruit or from multiple types of fruit. Such juices include, but are not limited to juices from fruit preparations conventionally found in yogurt products, such as berry juices, strawberries, peaches, or tropical fruits, as well as grape juice, white grape juice, apple juice, pear juice, apricot juice, pineapple juice, pomegranate juice, and passion fruit juice.

The exact amounts of fruit solid contents may be selected based on the particular type of fruit, keeping in mind the characteristics of the final product, such as carbohydrate content and glycemic properties. Exemplary ranges for fruit solid content are 2 to 20%; exemplary pH values range from 3.6 to 4.4; and exemplary BRIX and BOSTWICK values range from 5 to 50 and 5 and 12, respectively. For example, the BRIX of the fruit preparation may be about 10. The density of the fruit solid content may range from about 8.0 to 10.0 lbs/gal, preferably from 8.2 to 8.8 lbs/gal. These values include all intermediate values and subranges. For example, a fruit preparation may have acidity of about pH 3.9 a BRIX of about 31 and a BOSTWICK at 40° F./60 sec of about 9 cm. Its density may be about 9.5 lbs/gal. The amount of fruit preparation is also selected to provide suitable organoleptic properties to the yogurt-like product. Exemplary ranges are from 3-25% by mass, including all intermediate values and subranges, such as 5-20%, 10-15%, and 15-20%. Exemplary values include 3, 4, 5, 6, 7, 8, 9, 10, 11, 12, 13, 14, 15, 16, 17, 18, 19, 20, 21, 22, 23, 24 and 25%.

Examples of suitable fruit solids and flavors include apple, apricot, banana, blueberry, blueberries and cream, boysenberry, caramel, cheesecake, cherimoya, cherry, cherry-vanilla, chocolate, coconut, coffee, coffee-cappuccino, cranberry, custard, créme-brulee, guava, lemon, key lime, mango, margarita, mixed berries, orange, papaya, passionfruit, peach, peaches and cream, pineapple, pina-colada, pistachio, plum, pina colada, pomegranate, raspberry, raspberries and cream, raspberry-cranberry, raspberry-peach, spice, strawberry, strawberry-banana, strawberries and cream, strawberry-kiwi, tangerine, toffee, tropical, vanilla and vanilla cream.

The process of the invention may further comprise mixing conventional food additives into the dairy based product before or during inline mixing of the fruit and yogurt-like product components. Additives, such as acidulants, antioxidants, bulking agents, bulking sweeteners, colorants, dietary fiber, emulsifiers, enzymes, fat replacers, flavors, flavor enhancers, gases, preservatives, non-nutritive sweeteners, processing aids, stabilizers or thickeners which may be added to consumable foods and beverages are known in the art and are described by the Kirk-Othmer Encyclopedia of Chemical Technology, 4th edition, vol. 11, “Food Additives”, pages 805-833, which is incorporated by reference. For example, modified food corn starch, artificial and natural flavors, sodium citrate, malic acid, potassium sorbate, or annatto extract, caramel color, Red 40 or Blue 1 may be added. The type and amount of sweetener may be selected to minimize the glycemic load of the yogurt-like product. For example, a sweetener with a low glycemic index or a having a high degree of sweetness may be selected. Mineral content, such as potassium, sodium or calcium content may also be supplemented. For example, calcium content may be adjusted by adding calcium salts such as a calcium phosphate to provide a calcium content ranging from 0.2% to 1.0% or any intermediate value or subrange thereof. Natural sweeteners include sucrose, dextrose, fructose, or tagatose (which naturally occurs in some dairy products, and which has anti-hyperglycemic, prebiotic and anticariogenic properties). Fructose is a natural sugar found in many fruits and has a low glycemic index compared to glucose. Thus, while selection of a sugar such as fructose increases carbohydrate content, it reduces the glycemic load on an individual compared to use of higher glycemic sugars.

Sucralose is a low-calorie sweetener made from sucrose. It is about 600-times sweeter than sucrose and does not contain calories. Sucralose is stable under a wide range of different processing conditions and can be effectively used as a substitute for sucrose. Sucralose is made from sucrose and has no effects on blood glucose or serum insulin levels. Other sweeteners include but are not limited to acetsufame K, alitame, aspartame, cyclamate, erythritol glycyrrhizin, neohesperidin dihydrochalcone, neotame, saccharin, stevioside, or thaumatin. Sweeteners and normutritive sweeteners as well as their chemical and organoleptic properties, stability, and degrees of sweetness are described by the Kirk-Othmer Encyclopedia of Chemical Technology, 4^{th} edition, vol. 23, “Sweetners”, pages 556-582, which is hereby incorporated by reference. Sweetness inducers, enhancers and inhibitors may also be added to the yogurt-like product or used to adjust its organoleptic properties. These are also described by the Kirk-Othmer Encyclopedia of Chemical Technology, 4^{th} edition, pages 575-577, and are incorporated by reference.

Sweeteners may be added to the fermentation ingredients, to the yogurt-like product directly, to a fruit preparation prior to its mixture with the yogurt-like product, or may be added during mixture of the yogurt-like product and the fruit preparation.

In a preferred process, the low carbohydrate fermented milk (yogurt-like product or white mass) base product and fruit preparation are separately introduced and mixed by means of an inline mixer. Dynamic or static mixing may be used to mix the primary components. Suitable dynamic and static mixers are known in the art and any type of mixer may be used so long as it results in the production of a homogeneous product with the desired viscosity and organoleptic characteristics. One may select a suitable mixer from amongst those known in the art, for example, from those described by the Kirk-Othmer Encyclopedia of Chemical Technology, 4th edition, “Mixing and Blending”, vol. 16, pages 844-887, or by pages 201-204 of Yogurt Science and Technology, both of which are hereby incorporated by reference.

The massic ratio of yogurt-like base product or white mass:fruit preparation introduced into the inline static mixer ranges from 100-75: 0-25%. Depending on the characteristics of the yogurt-like product and the fruit preparation and any food additives, an appropriate ratio is selected to provide a final low carbohydrate diary product having a pH in the range of 4.0 to 4.5 and a viscosity in the range of 900 to 1,600 mPa·s. Viscosity may be determined using a Mettler RM180 Rheomat rotational viscometer.

After mixing is completed the low carbohydrate fruit-based and dairy-based product has a pH in the range of 3.4 to 4.6. Above a pH of 4.6, the mixture is less resistant to the growth of undesirable microorganisms. Other suitable pH ranges include pH 4.05 to 4.45, pH 4.1-4.4, and pH 4.2-4.3. However, any subrange or intermediate value in the above pH ranges is contemplated. Exemplary pH values are 3.4, 3.5, 3.6, 3.8, 4.0, 4.05, 4.1, 4.25, 4.35, 4.45, 4.5 or 4.6.

The low carbohydrate dairy product made by the process of the invention has viscosity in the range of 900 to 1,600 mPa·s. Other suitable viscosity ranges include 1,000 to 1,400 mPa·s, and 1,100-1,300 mPa·s. Exemplary viscosities are 900, 1,000, 1,050, 1,100, 1,200, 1,250, 1,300 and 1,400 and include any intermediate value or subrange of the ranges indicated above.

The resulting low carbohydrate dairy product may then be filled into containers and the containers palleted for distribution. The palletized product is shipped under refrigerated conditions.

Fiber may also be added to the low carbohydrate yogurt-like product. Addition of fiber can further reduce the glycemic index of the yogurt product, enhance its texture, improve its digestibility, or provide pro- or prebiotic properties to the yogurt-like product. The amount of fiber to be added may be determined based on the effects of the added fiber on organoleptic and glycemic properties of the fermented milk products. The fiber content may range from about 1-5%. For example, a product which provides a good source of fiber may have at least 2% added fiber or at least 2.5 g per serving. Both insoluble and soluble dietary fiber is not digestible by intestinal enzymes. Insoluble dietary fiber is not soluble in boiling water, whereas soluble fiber is.

Soluble fiber is a component of many fruits and vegetables and includes pectins, gums and mucilages. For example, soluble fiber appears in oat products, legumes, including beans, barley, citrus and other fruits, psyllium and gums, such as pectin, guar gum (galactomannan polymer) and gum arabic (Acacia gum) and konjac gum (glucomannan).

Insoluble fiber is a component of the outer coverings (bran) of grains such as corn, oats, rice and wheat or obtained as a component of fruits and vegetables. Grain germs, such as oat, rice or wheat germs are also good sources of insoluble fiber. Insoluble fiber decreases intestinal transit time slows the hydrolysis of starches and can delay the absorbtion of sugars. Other useful fibers include oat fiber or oat bran (contain both soluble and insoluble fiber), and the prebiotic compounds inulin, oligofructose, and maltodextrin.

A fiber ingredient may be selected for its ability to stabilize or improve the gellation or emulsification of the low-carbohydrate fermented dairy product.

To minimize carbohydrate content or reduce the glycemic index a fiber having no or very low net carbohydrate is selected. For example, inulins or oligofuctoses can provide a mild sweet taste and a full feeling like starchy foods, but are not absorbed and do not significantly affect blood sugar. Such compounds also have prebiotic activity and can enhance the growth of probiotic bacteria when ingested. For example, inulin can facilitate the growth of intestinal bifidobacteria. Compounds like inulins can also provide a creamy or smooth texture and even a fatlike mouthfeel without adding to the net carbohydrate content of a fermented milk product.

The yogurt-like product of the present invention can have a glycemic index of below 10, below 15, below 20, below 30, below 40, below 50 or below 60. Preferably the glycemic index of the product is kept low, however, a higher glycemic index may be counterbalanced by reducing the glycemic load of the yogurt-like product by keeping the net carbohydrate content low or by addition of one or more fiber(s) than slows the digestion and release of carbohydrates and sugars in the product.

### EXAMPLES

To a mixture of ultrafiltered milk, skim milk and cream, WPC and gelatin (dry) are added. The mixture is allowed to hydrate for about 30 mins and then is heated to about 140° F. and homogenized. The homogenized milk mixture is heated to approximately 198° F. and held for about 6.5 mins to kill pathogenic microorganisms.

Subsequently the mixture is cooled to a temperature of about 102° F. and inoculated with about 0.01% of a mixture of Lactobacillus bulgaricus and Streptococcus thermophilus. The mixture is held with minimal agitation at 102° F. until curd formation occurs and a break pH of about 4.60 is reached. To inhibit further reduction in pH and bacterial growth, the mixture (yogurt-like product or white mass) is agitated and cooled to about 68° F., filtered through a ⅛ inch wire mesh to remove lumps, and the filtered white mass or yogurt-like product is held up to 10 hours at this temperature.

The cooled yogurt-like product and fruit preparation in a massic ratio of approximately 90:10 is pumped in line static mixer (Admixer™) to produce a fruit composition having a pH of about 4.30 and a viscosity of about 1,200 mPa·s. The filled containers are shipped and refrigerated at a temperature of about 41° F. prior to sale.

### Modifications and Other Embodiments

Various modifications and variations of the disclosed processes and products and as well as the concept of the invention will be apparent to those skilled in the art without departing from the scope and spirit of the invention. Although the invention has been described in connection with specific preferred embodiments, it should be understood that the invention as claimed is not intended to be limited to such specific embodiments. Various modifications of the described modes for carrying out the invention which are obvious to those skilled in the food sciences, nutritional, microbiological, chemical or related fields are intended to be within the scope of the following claims.

### INCORPORATION BY REFERENCE

Each document, patent, patent application or patent publication cited by or referred to in this disclosure is incorporated by reference in its entirety.

1. A process for producing a reduced carbohydrate dairy and fruit product comprising:
mixing of a reduced carbohydrate fermented dairy base with an amount of a fruit preparation sufficient to form a product having:
a viscosity ranging from 900-1,600 mPa·s and
a pH ranging from 4.0 to 4.5,
wherein said reduced carbohydrate dairy and fruit product has less than 4.9% carbohydrate.

2. The process of claim 1, wherein said reduced carbohydrate dairy and fruit product has less than 3% carbohydrate.

3. The process of claim 1, wherein said reduced carbohydrate fermented milk base is produced from ultrafiltered skim milk.

4. The process of claim 1, wherein said reduced carbohydrate dairy base is produced from a mixture comprising skim milk, MPC, gelatin, WPC and water.

5. The process of claim 1, wherein said reduced carbohydrate dairy base is fermented from a mixture of ultrafiltered skim milk, cream, whey protein concentrate and Vitamins A and D.

6. The process of claim 1, wherein said reduced carbohydrate fermented dairy base is produced from ultrafiltered whole or low-fat milk.

7. The process of claim 1, wherein said reduced carbohydrate fermented dairy base contains Lactobacillus acidophilus or Lactobacillus bifidus, or both.

8. The process of claim 1, wherein the reduced-carbohydrate fermented dairy base is yogurt or a yogurt-like product.

9. The process of claim 1, wherein said fruit preparation is a fruit sauce.

10. The process of claim 1, where said fruit preparation is a fruit puree.

11. The process of claim 1, wherein said fruit preparation comprises pieces of fruit is less than 6 mm in diameter.

12. The process of claim 1, further comprising adding to said product one or more sweeteners selected from the group consisting of sucrose and dextrose.

13. The process of claim 1, further comprising adding to said product fructose.

14. The process of claim 1, further comprising adding to said product sucralose.

15. The process of claim 1, further comprising adding to said product tagatose.

16. The process of claim 1, further comprising adding to said product one or more sweeteners selected from the group consisting of aspartame, saccharin, cyclamate, acetsufame K, alitame, glycyrrhizin, stevioside, and thaumatin.

17. The process of claim 1, further comprising adding to said product one or more food additive(s).

18. The process of claim 1, further comprising adding to said product one or more flavoring(s).

19. The process of claim 1, further comprising adding to said product one or more vitamin(s) or mineral(s).

20. The process of claim 1, further comprising adding to said product one or more food color(s).

21. The process of claim 1, wherein said viscosity ranges from 900-1,600 mPa·s.

22. The process of claim 1, wherein said viscosity ranges from 1,000 to 1,400 mPa·s.

23. The process of claim 1, wherein said pH ranges from 4.1 to 4.4.

24. The process of claim 1, wherein said pH ranges from 4.2 to 4.3.

25. The process of claim 1, wherein said product has a total solids content in the range of about 5 to 15% by weight.

26. The process of claim 1, wherein said product has a protein content in the range of 0.5% to 5% by weight.

27. The process of claim 1, wherein said product has a fruit content ranging from 3% to 12% by weight.

28. A reduced carbohydrate fermented dairy product having less than 4.9% carbohydrate, a viscosity ranging from 900-1,600 mPa·s and a pH ranging from 4.1 to 4.5.

29. The reduced carbohydrate fermented dairy product of claim 28, which has less than 3% carbohydrate.

30. The reduced carbohydrate fermented dairy product of claim 28, which comprises a fermented dairy base which is yogurt or a yogurt-like product.

31. The reduced carbohydrate dairy product of claim 28, which is made by the process of claim 1.

32. The reduced carbohydrate dairy product of claim 28, further comprising at from 3-12% fruit preparation.

33. The reduced carbohydrate dairy product of claim 28, further comprising at least one sweetener.

34. The reduced carbohydrate dairy product of claim 28, further comprising sucralose.

35. The reduced carbohydrate product of claim 28, further comprising tagatose.

36. The reduced carbohydrate dairy product of claim 28, further comprising one or more sweeteners selected from the group consisting of sucrose and dextrose.

37. The reduced carbohydrate dairy product of claim 28, further comprising fructose.

38. The low carbohydrate dairy product of claim 28, further comprising one or more sweeteners selected from the group consisting of aspartame, saccharin, cyclamate, acetsufame K, alitame, glycyrrhizin, stevioside, and thaumatin.
